(19) United States
(12) Patent Application Publication
(10) Pub. No.: US 2023/0252973 A1
(43) Pub. Date: Aug. 10, 2023

(54) SYSTEM AND METHOD FOR PROVIDING A TEXT-TO-SPEECH AUDIO STREAM

(71) Applicant: The Toronto-Dominion Bank, Toronto (CA)

(72) Inventors: Warren A. PRATTEN, London (CA); Graham Allan ANDERSON, Guelph (CA)

(73) Assignee: The Toronto-Dominion Bank, Toronto (CA)

(21) Appl. No.: 17/668,786

(22) Filed: Feb. 10, 2022

(51) Int. Cl. G10L 13/08; G10L 13/02; H04L 9/32

(52) U.S. Cl. CPC G10L 13/08; G10L 13/02; H04L 9/3213

(57) ABSTRACT

A self-service system comprises a communications module; a processor coupled with the communications module; and a memory coupled to the processor and storing processor-executable instructions which, when executed by the processor, configure the processor to determine that a text-to-speech audio stream is to be sent to a mobile device; initiate a trusted session between the self-service system and the mobile device; engage a text-to-speech module to convert text displayed on a display screen of the self-service system to the text-to-speech audio stream; and send, via the communications module and to the mobile device, a signal that includes the text-to-speech audio stream.

### TECHNICAL FIELD

The present application relates to systems and methods for providing a text-to-speech audio stream.

### BACKGROUND

Self-service systems allow customers to perform operations without requiring assistance from an employee such as a bank teller, gas station attendant, grocery store clerk, etc.

It may be difficult for customers with disabilities to use self-service systems.

### BRIEF DESCRIPTION OF THE DRAWINGS drawings:

Embodiments are described in detail below, with reference to the following

FIG. 1 is a schematic operation diagram illustrating an operating environment of a self-service system in the form of an automated teller machine according to an embodiment;

FIG. 2 is a logical block diagram of the automated teller machine of FIG. 1;

FIG. 3 is a high-level schematic diagram of an example computer device;

FIG. 4 shows a simplified organization of software components stored in a memory of the example computer device of FIG. 3;

FIG. 5 is a flowchart showing operations performed by an automated teller machine in authenticating an authentication token according to an embodiment;

FIG. 6 is a flowchart showing operations performed by an automated teller machine in providing a text-to-speech audio stream according to an embodiment;

FIG. 7 is a flowchart showing operations performed by an automated teller machine in initiating a trusted session according to an embodiment; and

FIG. 8 is a flowchart showing operations performed by an automated teller machine in performing one or more tasks according to an embodiment,

Like reference numerals are used in the drawings to denote like elements and features.

### DETAILED DESCRIPTION OF VARIOUS EMBODIMENTS

Accordingly, in an aspect there is provided a self-service system comprising a communications module; a processor coupled with the communications module; and a memory coupled to the processor and storing processor-executable instructions which, when executed by the processor, configure the processor to determine that a text-to-speech audio stream is to be sent to a mobile device; initiate a trusted session between the self-service system and the mobile device; engage a text-to-speech module to convert text displayed on a display screen of the self-service system to the text-to-speech audio stream; and send, via the communications module and to the mobile device, a signal that includes the text-to-speech audio stream.

In one or more embodiments, the processor-executable instructions, when executed by the processor, further configure the processor to receive an indication of an authentication token from one of the mobile device or an access card.

In one or more embodiments, when initiating the trusted session between the self-service system and the mobile device, the processor-executable instructions, when executed by the processor, further configure the processor to obtain, from a database and based on the indication of the authentication token, a telephone number of the mobile device; send, via the communications module and to the mobile device, a signal representing a request to initiate a telephone call; and receive, via the communications module and from the mobile device, a signal indicating initiation of the telephone call.

In one or more embodiments, when sending, via the communication module and to the mobile device, the signal that includes the text-to-speech audio stream, the processor-executable instructions, when executed by the processor, further configure the processor to provide the text-to-speech audio stream to the mobile device via the telephone call.

In one or more embodiments, the processor-executable instructions, when executed by the processor, further configure the processor to receive, via the communications module and from the mobile device, a signal indicating termination of the telephone call; and terminate the trusted session between the self-service system and the mobile device.

In one or more embodiments, the mobile device outputs the text-to-speech audio stream to a headset connected to the mobile device.

In one or more embodiments, the text-to-speech audio stream includes a request for a user to submit an instruction via the mobile device.

In one or more embodiments, the processor-executable instructions, when executed by the processor, further configure the processor to receive, via the communications module and from the mobile device, a signal that represents one or more input commands entered by the user via the mobile device; determine one or more tasks to be performed based on the one or more input commands entered by the user; and perform the one or more tasks.

In one or more embodiments, the one or more input commands include pressing one or more buttons on a keypad associated with the mobile device.

In one or more embodiments, the self-service system includes one of an automated teller machine (ATM), a gas station terminal or a self-checkout terminal.

In one or more embodiments, when determining that the text-to-speech audio stream is to be sent to the mobile device, the processor-executable instructions, when executed by the processor, further configure the processor to, at least one of determine, based on account information stored in a database, that the text-to-speech audio stream is required, receive an indication that the text-to-audio stream is required, or determine that an audio jack of the self-service system is in an unconnected state.

According to another aspect there is provided a computer-implemented method executed by a processor of a self-service system, the method comprising determining that a text-to-speech audio stream is to be sent to a mobile device; initiating a trusted session between the self-service system and the mobile device; engaging a text-to-speech module to convert text displayed on a display screen of the self-service system to the text-to-speech audio stream; and sending, via a communications module and to the mobile device, a signal that includes the text-to-speech audio stream.

In one or more embodiments, the method further comprises receiving an indication of an authentication token from one of the mobile device or an access card.

In one or more embodiments, initiating the trusted session between the self-service system and the mobile device comprises obtaining, from a database and based on the indication of the authentication token, a telephone number of the mobile device; sending, via the communications module and to the mobile device, a signal representing a request to initiate a telephone call; and receiving, via the communications module and from the mobile device, a signal indicating initiation of the telephone call.

In one or more embodiments, sending, via the communication module and to the mobile device, the signal that includes the text-to-speech audio stream comprises providing the text-to-speech audio stream to the mobile device via the telephone call.

In one or more embodiments, the mobile device outputs the text-to-speech audio stream to a headset connected to the mobile device.

In one or more embodiments, the text-to-speech audio stream includes a request for a user to submit an instruction via the mobile device.

In one or more embodiments, the method further comprises receiving, via the communications module and from the mobile device, a signal that represents one or more input commands entered by the user via the mobile device; determining one or more tasks to be performed based on the one or more input commands entered by the user; and performing the one or more tasks.

In one or more embodiments, determining that the text-to-speech audio stream is to be sent to the mobile device further comprises determining, based on account information stored in a database, that the text-to-speech audio stream is required; receiving an indication that the text-to-speech audio stream is required; or determining that an audio jack of the self-service system is in an unconnected state.

According to another aspect there is provided a non-transitory computer readable storage medium comprising computer-executable instructions which, when executed, configure a processor of a self-service system to determine that a text-to-speech audio stream is to be sent to a mobile device; initiate a trusted session between the self-service system and the mobile device; engage a text-to-speech module to convert text displayed on a display screen of the self-service system to the text-to-speech audio stream; and send, via a communications module and to the mobile device, a signal that includes the text-to-speech audio stream.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

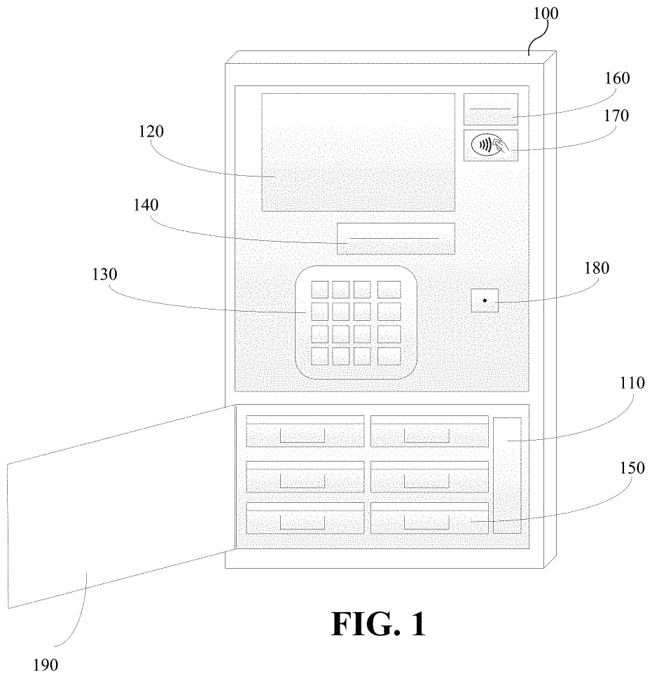

FIG. 1 illustrates example components of a self-service system in the form of an automated teller machine 100. The automated teller machine 100 is adapted to provide access to banking services such as, for example, withdrawals and deposits. As shown in FIG. 1, the automated teller machine 100 may include a controller 110, a display 120, a keypad 130, an item dispenser 140, cassettes 150, a card reader 160, a wireless token reader 170 and an audio jack 180.

As further described below, the controller 110 is a computing device. For example, the controller 110 may include a processor that executes instructions retrieved from a computer-readable medium thereby causing the automated teller machine 100 to perform operations for providing access to banking services.

The display 120 may for example, be a liquid-crystal display (LCD), a cathode-ray tube (CRT), or the like. The display 120 may present a user interface to a user of the automated teller machine 100.

The keypad 130 is an input device allowing input to be provided to the automated teller machine 100. Input received via the keypad 130 may be conveyed to the controller 110. The keypad 130 may be used by a user to provide a personal identification number (PIN) to the automated teller machine 100 as a part of authenticating to the automated teller machine 100.

The item dispenser 140 is a device allowing value instruments to be dispensed by the automated teller machine 100. For example, it may be that the item dispenser 140 provides a single slot through which value instruments may be dispensed. Additionally or alternatively, the item dispenser 140 may provide multiple slots. It may be that components or units of the item dispenser 140 are specialized to a particular type or types of value instrument. For example, a particular component or unit of the item dispenser 140 may be adapted to receiving and/or dispensing banknotes of one denomination, while another component or unit may be adapted to receiving and/or dispensing banknotes of another denomination. Alternatively, it may be that the item dispenser 140 is a monolithic unit that handles all manner of value instruments.

As mentioned above, the automated teller machine includes one or more cassettes 150. The item dispenser 140 may be in communication with the cassettes 150. Some or all of the cassettes 150 may be adapted to dispense value instruments. For example, some of the cassettes 150 may be for dispensing banknotes of particular denominations.

The item dispenser 140 and the cassettes 150 may be collectively considered a value instrument dispenser adapted to dispense value instruments such as to satisfy withdrawals from the automated teller machine 100.

The card reader 160 allows data to be read from a card or access card such as for example a common ISO-sized ATM or cheque card. For example, the card reader 160 may allow data to be read from magnetic stripe cards and/or chip cards. In some embodiments, the card reader 160 may require a card to be swiped through it to be read (a so-called “swipe reader”) and/or it may allow a card to be inserted into it for reading (a so-called “dip reader”). In some embodiments, the card reader 160 may be adapted to allow inserted cards to be retained by the automated teller machine 100 indefinitely (such as if fraud is suspected) and/or for the period of a session.

The wireless token reader 170 allows data to be exchanged with wireless authentication tokens. The wireless token reader 170 may include a wireless communications module. The wireless token reader 170 may communicate with authentication tokens using one or more wireless protocols. In one or more embodiments, the wireless token reader may use nearfield communication (NFC) to communicate with authentication tokens. Authentication tokens with which the wireless token reader 170 communicates may take a variety of forms. For example, authentication tokens with which the wireless token reader 170 may communicate may include NFC-enabled ISO-sized cards and/or NFC-enabled devices such as, for example, NFC-enabled smartphones, smartwatches or other wearables, or implants such as, for example, implantable NFC-enabled microchips.

The audio jack 180 is connected to the controller 110 and is configured to receive a connector such as for example a phone connector, phone jack, audio jack, headphone jack or jack plug. The connector may include a male connector of a pair of headphones. In a connected state, the audio jack 180 is configured to provide audio signals received from the controller 110 to the headphones.

One or both of the controller 110 and the cassettes 150 may, as illustrated, be disposed within a cabinet 190 of the automated teller machine 100.

Although not shown, the automated teller machine 100 may be connected to one or more back-end server computer systems via a network. The one or more back-end server computer systems may be located remote from the automated teller machine 100. Put another way, the automated teller machine and the one or more back-end server computer systems may be in geographically disparate locations

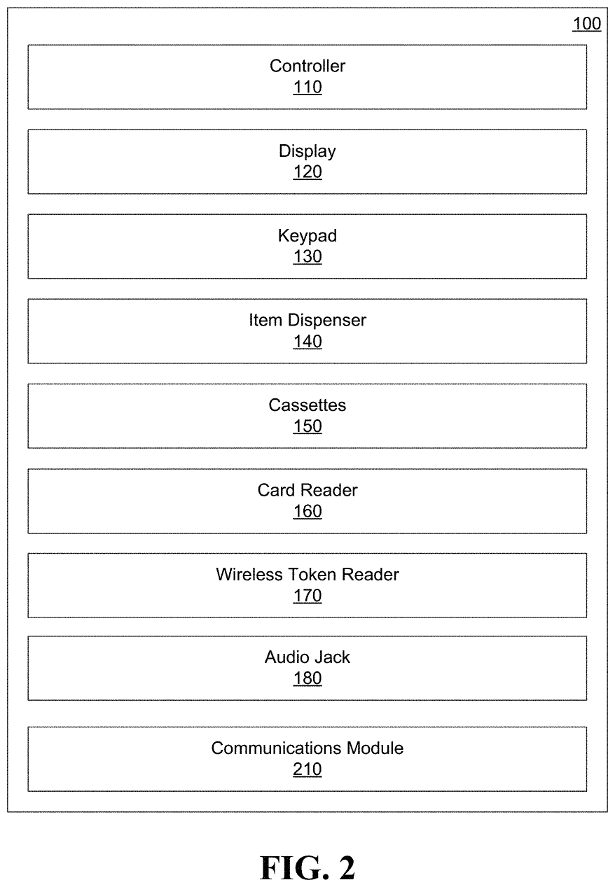

FIG. 2 is a logical block diagram of the automated teller machine 100. As described above, the automated teller machine 100 may include a controller 110, a display 120, a keypad 130, an item dispenser 140, cassettes 150, a card reader 160, a wireless token reader 170 and an audio jack 180 as described above. Additionally, as shown in FIG. 2, the automated teller machine 100 may include a communications module 210.

The communications module 210 allows the automated teller machine 100 to communicate with other computing devices and/or various communications networks. Put another way, the communications module 210 may allow the automated teller machine 100 to send or receive communications signals. Communications signals may be sent or received according to one or more protocols or according to one or more standards. For example, the communications module 210 may allow the automated teller machine 100 to communicate via telephone network and/or a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 210 may allow the example computer device 300 to communicate using near-field communication (NFC), via Wi-Fi™, using Bluetooth™ or via some combination of one or more networks or protocols.

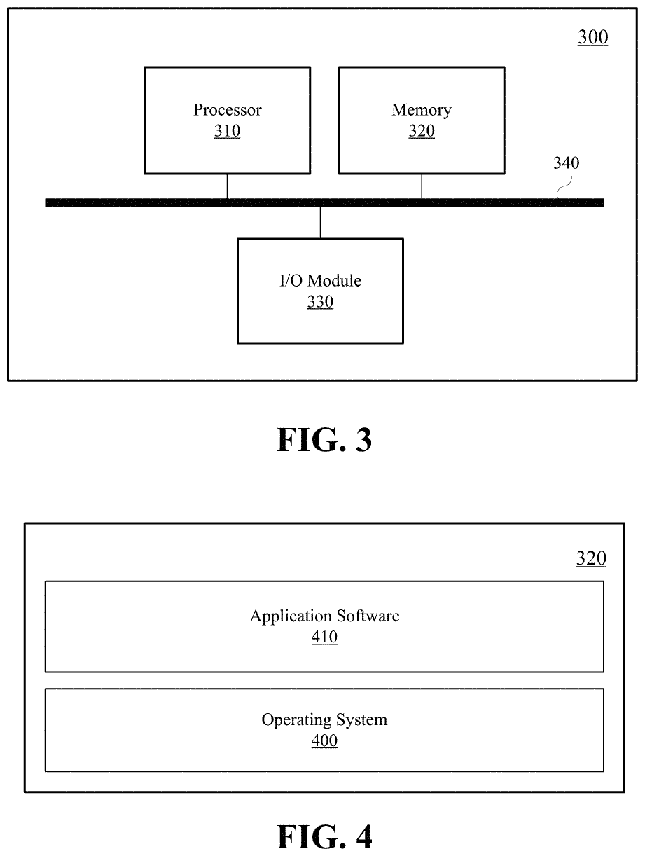

FIG. 3 is a high-level operation diagram of an example computer device 300. In some embodiments, the example computer device 300 may be exemplary of the controller 110 (FIG. 1). The automated teller machine 100 (FIG. 1) includes software that adapts it to perform a particular function. The software may provide one or more user interfaces (e.g. using the display 120) for accessing the functionality of the automated teller machine.

The example computer device 300 includes a variety of modules. For example, as illustrated, the example computer device 300 may include a processor 310, a memory 320, and an input/output (I/O) module 330. As illustrated, the foregoing example modules of the example computer device 300 are in communication over a bus 340.

The processor 310 is a hardware processor. The processor 310 may, for example, be one or more ARM, Intel ×86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 300.

The I/O module 330 allows the example computer device 300 to interact with devices such as, for example, peripherals to send and receive data. The I/O module 330 may, for example, allow the example computer device 300 to interface with input devices such as, for example, keypads, keyboards, pointing devices, and the like. In another example, the I/O module 330 may, for example, allow the example computer device 300 to interface with output devices such as, for example, displays, printers, and the like. In a particular example, where the example computer device 300 forms a part of the automated teller machine 100 (FIG. 1) such as, for example, if the example computer device 300 is or forms a part of the controller 110 (FIG. 1) of the automated teller machine 100, the I/O module 330 may allow the example computer device 300 to interface with, for example, one or more of the display 120, the keypad 130, the item dispenser 140, cassettes 150, the card reader 160, the wireless token reader 170, the audio jack 180 and/or the communications module 210.

Software comprising instructions is executed by the processor 310 from a computer-readable medium. For example, software may be loaded into random-access memory from persistent storage of the memory 320. Additionally, or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and application software 410.

The operating system 400 is software. The operating system 400 allows the application software 410 to access the processor 310 (FIG. 3), the memory 320, and the I/O module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application software 410 adapts the example computer device 300, in combination with the operating system 400, to operate as a device performing a particular function. For example, the application software 410 may cooperate with the operating system 400 to adapt a suitable embodiment of the example computer device 300 to operate as the controller 110 (FIG. 2) of the automated teller machine 100 (FIG. 1).

Operations performed by the automated teller machine 100 will now be described.

The automated teller machine 100 may perform one or more tasks associated with an account. Prior to performing the one or more tasks, the automated teller machine 100 may require a user to authenticate using, for example, an authentication token.

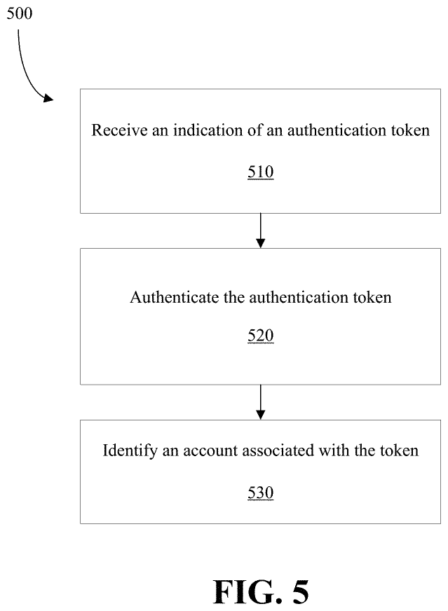

Reference is made to FIG. 5, which illustrates, in flowchart form, a method 500 for authenticating. The method 500 may be implemented by a computing device having suitable processor-executable instructions for causing the computing device to carry out the described operations. The method 500 may be implemented, in whole or in part, by the controller 110 of the automated teller machine 100. In one or more embodiments, the controller 110 may offload some of the operations to one or more back-end server computer servers associated with the automated teller machine 100 through a network.

The method 500 includes receiving an indication of an authentication token (step 510).

In one or more embodiments, the indication of the authentication token may be received via the card reader 160. For example, a card or access card such as for example a common ISO-sized ATM, cheque, credit or debit card may be inserted into the card reader 160.

In one or more embodiments, the indication of the authentication token may be detected via the wireless token reader 170. For example, the automated teller machine 100 may detect that an authentication token capable of wireless communication has been brought into communication range of the wireless token reader 170. Additionally or alternatively, another wireless communications module such as for example the communications module 210 may be employed to detect a proximate authentication token.

The authentication token is a physical device maintaining metadata, including metadata for authenticating wirelessly with devices such as the automated teller machine 100 and metadata allowing identification of at least one account of a financial institution. The wireless authentication token may take a variety of forms. For example, the wireless authentication token may include an NFC-enabled token such as for example an NFC card like an NFC credit or debit card (e.g. a contactless payment card). As another example, the wireless authentication token may include a device such as for example a smartphone, a fob, a tablet, a smartwatch or other wearable, or an implant such as for example an implantable microchip. The wireless authentication token may be an NFC-enabled smartphone. For example, the wireless authentication token may be an NFC-enabled smartphone supporting NFC-card emulation.

The authentication token may be brought into communication range of the automated teller machine 100 by a user tapping the contactless payment card or device on the wireless token reader 170.

The method 500 includes authenticating the authentication token (step 520).

The authenticating may require two-factor authentication. For example, in one or more embodiments, the automated teller machine 100 may require the user to enter a PIN associated with the card that was inserted into the card reader 160. The user may enter the PIN using, for example, the keypad 130 of the automated teller machine 100. Responsive to receiving the PIN, the automated teller machine 100 may determine that the PIN is indeed associated or linked with the card.

In one or more embodiments, the automated teller machine 100 may communicate with the authentication token to authenticate the token. For example, the automated teller machine 100 and the authentication token may exchange one or more messages to cryptographically authenticate the authentication token. For example, a challenge-response cryptographic protocol may be employed in authenticating the authentication token.

In some embodiments, the automated teller machine 100 may perform authentication of the authentication token offline, that is, without the automated teller machine 100 communicating with any remote servers. In other embodiments, authentication may involve an online authentication technique in which the automated teller machine 100 communicates with one or more back-end server computer systems via a network. In one or more embodiments, the network may be an automated teller machine network such as, for example, the PLUS™ or Interac™ networks. It may be that the automated teller machine 100 acts as a proxy or relay for communications between a remote authentication server responsible for authenticating the authentication token as valid and the authentication token. Put another way, the automated teller machine 100 communicating wirelessly with the authentication token to authenticate it may include the automated teller machine acting as a relay for communications between the authentication token and a remote authentication server.

The method 500 includes identifying an account associated with the authentication token (step 530).

In one or more embodiments, the automated teller machine 100 may communicate with the authentication token to receive information identifying an account associated with the token. For example, the authentication token may provide a payment account number (PAN) to the automated teller machine 100. In one or more embodiments, the automated teller machine 100 may receive an identifying value from the automated teller machine 100 and may then use that value to perform a look-up to identify an account such as, for example, a bank account number. In a particular example, the automated teller machine 100 may communicate one or more values received from the authentication token and/or determined based on the authentication token to one or more back-end server computer systems and the one or more back-end server computer system may perform one or more look-ups in order to obtain account information and may communicate the account information to the automated teller machine 100. A network such as for example the PLUS™ or Interac™ networks may additionally be used.

Once authentication has been completed, the automated teller machine 100 may perform one or more tasks associated with the account. The tasks may include depositing funds, withdrawing funds, determining an account balance, etc.

A user or customer of the automated teller machine 100 may have difficulty using the automated teller machine 100 and this may be due to a disability, for example. As such, the automated teller machine 100 may include one or more features to help those with disabilities. The one or more features may include providing a text-to-speech audio stream.

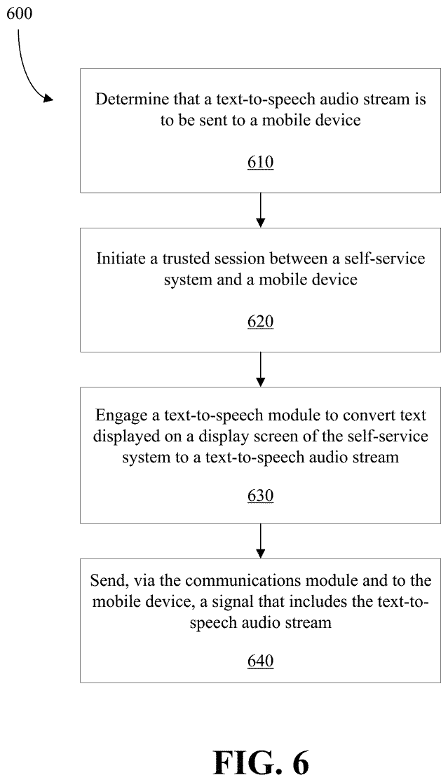

Reference is made to FIG. 6, which illustrates, in flowchart form, a method 600 for providing a text-to-speech audio stream. The method 600 may be implemented by a computing device having suitable processor-executable instructions for causing the computing device to carry out the described operations. The method 600 may be implemented, in whole or in part, by the controller 110 of the automated teller machine 100. In one or more embodiments, the controller 110 may offload some of the operations to one or more back-end server computer servers associated with the automated teller machine 100 through a network.

The method 600 includes determining that a text-to-speech audio stream is to be sent to a mobile device (step 610).

The automated teller machine 100 may determine that the text-to-speech audio stream is required and that the text-to-speech audio stream is to be sent to the mobile device.

In one or more embodiments, account information may identify that the user or customer requires that the text-to-speech audio stream be provided. For example, the account identified during step 530 of the method 500 may be associated with account information stored in the database and the account information may identify that the user or customer requires that the text-to-speech audio stream be provided. As another example, the automated teller machine 100 may receive an indication that the text-to-speech audio stream is required. For example, the display screen of the automated teller machine 100 may include a selectable option for indicating that the user or customer requires that the text-to-speech audio stream be provided. As yet another example, the automated teller machine 100 may include a selectable button for indicating that the user or customer requires that the text-to-speech audio stream be provided.

It will be appreciated that the automated teller machine 100 may include an audio jack 180. The automated teller machine 100 may determine that the audio jack 180 is in a connected state, that is, that the audio jack 180 is currently connected to a headset such as a pair of headphones or a pair of earphones. Responsive to determining that the audio jack 180 is in the connected state, the automated teller machine 100 may determine that the text-to-speech audio stream is required and may determine that the text-to-speech audio stream is to be provided via the audio jack.

The automated teller machine 100 may determine that the audio jack 180 is in an unconnected state and as such the automated teller machine 100 may determine that the text-to-speech audio stream is to be provided to the mobile device.

It will be appreciated that in embodiments where the automated teller machine 100 does not include an audio jack, the automated teller machine 100 may determine that the text-to-speech audio stream is to be sent to the mobile device by determining that the text-to-speech audio stream is required.

The method 600 includes initiating a trusted session between a self-service system and the mobile device (step 620).

In one or more embodiments, the trusted session may be initiated only once authentication has been completed. For example, a customer may insert the card or access card into the card reader 160 and may enter the PIN associated with the card as described herein with reference to the method 500. Responsive to successful authentication, the automated teller machine 100 may perform operations to initiate the trusted session.

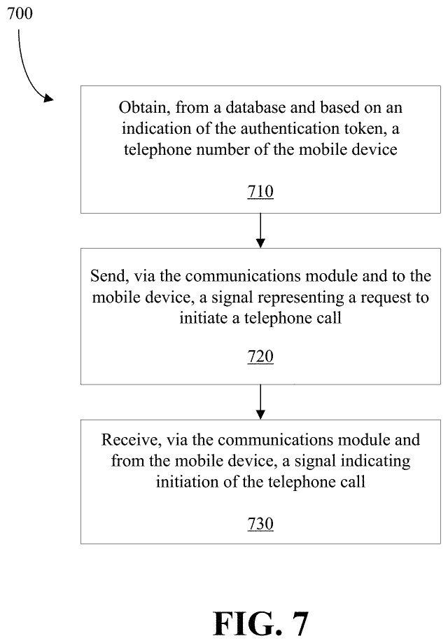

Reference is made to FIG. 7, which illustrates, in flowchart form, a method 700 for initiating a trusted session. The method 700 may be implemented by a computing device having suitable processor-executable instructions for causing the computing device to carry out the described operations. The method 700 may be implemented, in whole or in part, by the controller 110 of the automated teller machine 100. In one or more embodiments, the controller 110 may offload some of the operations to one or more back-end server computer servers associated with the automated teller machine 100 through a network.

The method 700 includes obtaining, from a database and based on an indication of the authentication token, a telephone number of the mobile device (step 710).

During authentication, an account associated with the authentication token may be identified. In this embodiment, a database may store account information for the account and the account information may include, for example, a name, an address, a telephone number, a mobile telephone number, etc. of the user. As such, the automated teller machine 100 and/or the one or more back-end server computer servers may send a signal to the database that includes information identifying the account and includes a request for the mobile telephone number. The database may obtain the telephone number and may send a signal to the automated teller machine 100 and/or the one or more back-end server computer servers that includes the mobile telephone number.

The method 700 includes sending, via the communications module and to the mobile device, a signal representing a request to initiate a telephone call (step 720).

In one or more embodiments, the automated teller machine 100 may engage the communications module 210 to send the signal representing the request to initiate the telephone call. Put another way, as previously mentioned, the communications module 210 allows the automated teller machine 100 to communicate via a telephone network and/or a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. As such, the communications module 210 may allow the automated teller machine 100 to initiate a telephone call by dialing the mobile telephone number obtained during step 710.

The request to initiate the telephone call is sent via the telephone network to the mobile telephone number and in response the mobile device rings or otherwise notifies the user of the telephone call.

The method 700 includes receiving, via the communications module and from the mobile device, a signal indicating initiation of the telephone call (step 730).

The user may answer the telephone call by pressing, for example, a call answer button displayed on a display screen of the mobile device. The mobile device may send a signal via the telephone network indicating that the call has been answered. In response, the communications module 210 may receive a signal indicating initiation of the telephone call. In this manner, a trusted session between the automated teller machine 100 and the mobile device is initiated.

It will be appreciated that in one or more embodiments, additional or alternative operations may be performed to initiate the trusted session. For example, in one or more embodiments, the operations performed by the automated teller machine 100 to initiate the trusted session may include enabling wireless communication. In one or more embodiments, wireless communication may only be enabled responsive to successful authentication. For example, the automated teller machine 100 may enter discovery mode and thus may connect to the mobile device via Bluetooth. Specifically, the user may operate the mobile device to navigate to a Bluetooth device configuration application which may identify or detect the automated teller machine 100 as a device that is available for communication via Bluetooth. The user may select the automated teller machine 100 and the mobile device and the automated teller machine 100 may engage in a trusted session via Bluetooth. In one or more embodiments, responsive to selecting the automated teller machine 100, the automated teller machine 100 may display a code such as a four (4) digit code on the display screen thereof and the user may be prompted to enter the same four (4) digit code using a keypad associated with the mobile device and this may be done to ensure that the mobile device is indeed the mobile device of the user standing in front of the automated teller machine 100. In another embodiment, the four (4) digit code may not be displayed on the display screen of the automated teller machine 100 but may instead be the PIN entered by the user during authentication. For example, the display screen of the automated teller machine 100 may display a message requesting that the user enter the same PIN that is associated with the card that was inserted into the card reader 160 and this may be done to initiate the trusted session.

As another example, in one or more embodiments, the automated teller machine 100 may additionally or alternatively enable a Wi-Fi Access Point that may be used to initiate the trusted session with the mobile device. In one or more embodiments, the Wi-Fi Access Point may only be available responsive to successful authentication. For example, the automated teller machine 100 may be listed as an available Wi-Fi connection and the user may operate the mobile device to navigate to a Wi-Fi connection configuration application which may identify or detect the automated teller machine 100 as a device that is a Wi-Fi Access Point. The user may select the automated teller machine 100 and the mobile device and the automated teller machine 100 may engage in a trusted session via Wi-Fi. It will be appreciated that the automated teller machine 100 may require the user to enter a four (4) digit code as described previously.

As yet another example, in one or more embodiments, the automated teller machine 100 may additionally or alternatively display a machine-readable code such as for example a quick response (QR) code. In one or more embodiments, the machine-readable code may only be displayed responsive to successful authentication. In this example, a camera or scanning device associated with the mobile device may be used to scan or otherwise read the machine-readable code and in response, the mobile device may be directed to a particular mobile application, web page, etc. that may be used to initiate the trusted session. The machine-readable code may additionally or alternatively be displayed on the automated teller machine 100. For example, a sticker or other indicia may be displayed or stuck to the cabinet of the automated teller machine 100.

The method 600 includes engaging a text-to-speech module to convert text displayed on a display screen of the self-service system to a text-to-speech audio stream (step 630).

The text-to-speech module may be engaged by the controller 110 of the automated teller machine 100. The text-to-speech module may convert text displayed on the display screen of the self-service system to a text-to-speech audio stream. The text-to-speech audio stream, when output by an acoustic device, may include a reading of what is being displayed on the display screen. It will be appreciated that the text-to-speech audio stream may include additional text or audio and the additional text or audio may be inserted into the text-to-speech audio stream. The additional text or audio may be pre-generated and stored in memory of the automated teller machine 100. For example, the text-to-speech audio stream may include audio based on what is being displayed on the display screen of the automated teller machine 100 and may include audio that includes a request for a user to submit an instruction via the mobile device. The request for the user to submit the instruction via the mobile device may not necessarily be generated based on the text that is displayed on the display screen of the automated teller machine 100, but rather may be a pre-generated audio stream that is stored in memory of the automated teller machine 100.

In one example, the text on the display screen of the automated teller machine 100 may read “Please select the amount of money you would like to withdrawal” and thus the text-to-speech audio stream may cause the mobile device to output audio “Please select the amount of money you would like to withdrawal.” Although not displayed on the display screen of the automated teller machine 100, the text-to-speech audio stream may include a request for the user to submit an instruction via the mobile device. For example, the text-to-speech audio stream may cause the mobile device to output audio “Please press one to withdraw $20, two to withdraw $40, three to withdraw $50, four to withdraw $100, five to withdraw $200, and six to enter a different amount.”

The method 600 includes sending, via the communications module and to the mobile device, a signal that includes the text-to-speech audio stream (step 640).

The automated teller machine 100 sends a signal that includes the text-to-speech audio stream to the mobile device. It will be appreciated that the text-to-speech audio stream may be sent within or during the trusted session.

For example, in embodiments where the trusted session is initiated via a telephone call, the text-to-speech audio stream may be provided to the mobile device via the telephone call. As another example, in embodiments where the trusted session is initiated via Bluetooth, the text-to-speech audio stream may be provided to the mobile device via Bluetooth.

Responsive to receiving the text-to-speech audio stream, the mobile device may output the text-to-speech audio stream to the user. For example, the mobile device may output the text-to-speech audio stream to a wired or wireless headset such as a pair of headphones or a pair of earphones that is connected to the mobile device. In another example, the mobile device may output the text-to-speech audio stream using a speaker associated with the mobile device.

During the trusted session, the user may enter input commands on the mobile device and the input commands may be used to request that the automated teller machine 100 perform one or more tasks.

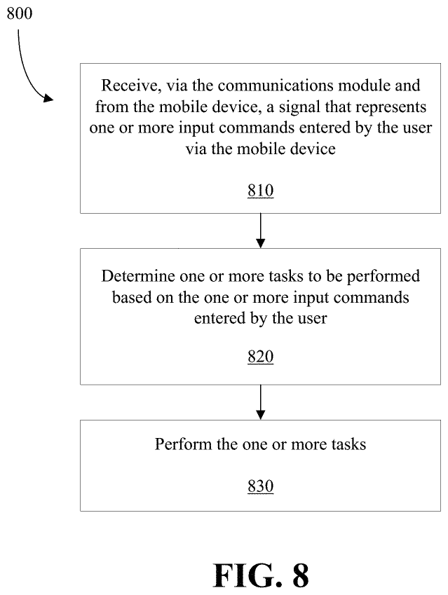

Reference is made to FIG. 8, which illustrates, in flowchart form, a method 800 for performing one or more tasks. The method 800 may be implemented by a computing device having suitable processor-executable instructions for causing the computing device to carry out the described operations. The method 800 may be implemented, in whole or in part, by the controller 110 of the automated teller machine 100. In one or more embodiments, the controller 110 may offload some of the operations to one or more back-end server computer servers associated with the automated teller machine 100 through a network.

The method 800 includes receiving, via the communications module and from the mobile device, a signal that represents one or more input commands entered by the user via the mobile device (step 810).

As mentioned, the text-to-speech audio stream may include a request for a user to submit an instruction via the mobile device. For example, the text on the display screen of the automated teller machine 100 may read “Please select the amount of money you would like to withdraw” and thus the text-to-speech audio stream may cause the mobile device to output audio “Please select the amount of money you would like to withdraw.” Although not displayed on the display screen of the automated teller machine 100, the text-to-speech audio stream may include a request for the user to submit an instruction via the mobile device. For example, the text-to-speech audio stream may cause the mobile device to output audio “Please press one to withdraw $20, two to withdraw $40, three to withdraw $50, four to withdraw $100, five to withdraw $200, and six to enter a different amount.”

The user may enter the instruction using the mobile device. For example, the user may press three on a keypad of the mobile device (which may be a keypad displayed on a display screen of the mobile device). In response, the mobile device may send a signal that represents the command entered by the user. The command may be, for example, an indication that the number three was pressed on the keypad. The automated teller machine 100 may receive the signal that represents the command.

The method 800 includes determining one or more tasks to be performed based on the one or more input commands entered by the user (step 820).

The automated teller machine 100 receives the signal that represents the command and determines one or more tasks to be performed. For example, the command may include the indication that the number three was pressed on the keypad. As such, the automated teller machine 100 may determine that the task to be performed includes withdrawing (or dispensing) $50.

The method 800 includes performing the one or more tasks (step 830).

Responsive to determining the one or more tasks to be performed, the automated teller machine 100 performs the one or more tasks. For example, the automated teller machine 100 may perform operations to dispense $50 and as such the task of withdrawing (or dispensing) $50 is performed.

It will be appreciated that other tasks that may be performed by the automated teller machine 100 may include, for example, performing operations to accept a deposit, performing operations to transfer funds between accounts, etc.

It will be appreciated that the trusted session may be terminated and this may be done by the automated teller machine 100 in response to the user indicating that the session is to be terminated. For example, the user may select a selectable option to terminate the session and/or may request that their card be returned by the automated teller machine 100.

In one or more embodiments, where the trusted session is initiated via telephone call, the automated teller machine 100 may receive a signal indicating termination of the telephone call. For example, the user may select a selectable option on a display screen of the mobile device to terminate the telephone call and in response the mobile device may send a signal indicating termination of the telephone call. The telephone call may end and this may terminate the trusted session between the automated teller machine 100 and the mobile device.

As described herein, a trusted session may be initiated between the automated teller machine 100 and the mobile device and this may only be done once authentication has been completed. It will be appreciated that the trusted session may be terminated once the user has completed using the automated teller machine 100. For example, the user may receive their card back from the automated teller machine 100 or may select a selectable option indicating that the user has completed using the automated teller machine 100 and in response the trusted session may be automatically terminated. In terminating the session, the automated teller machine 100 may perform operations such as for example disabling wireless communication, disabling a Wi-Fi access point, etc.

Although embodiments described herein include a self-service system in the form of an automated teller machine, those skilled in the art will appreciate that other self-service systems may be employed. Example self-service systems include gas station terminals, self-checkout terminals such as for example self-checkout terminals located at grocery stores, movie theater terminals, etc.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or nonvolatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A self-service system comprising:
a communications module;
a processor coupled with the communications module; and
a memory coupled to the processor and storing processor-executable instructions which, when executed by the processor, configure the processor to:
determine that a text-to-speech audio stream is to be sent to a mobile device;
initiate a trusted session between the self-service system and the mobile device;
engage a text-to-speech module to convert text displayed on a display screen of the self-service system to the text-to-speech audio stream; and
send, via the communications module and to the mobile device, a signal that includes the text-to-speech audio stream.

2. The self-service system of claim 1, wherein the processor-executable instructions, when executed by the processor, further configure the processor to:
receive an indication of an authentication token from one of the mobile device or an access card.

3. The self-service system of claim 2, wherein when initiating the trusted session between the self-service system and the mobile device, the processor-executable instructions, when executed by the processor, further configure the processor to:
obtain, from a database and based on the indication of the authentication token, a telephone number of the mobile device;
send, via the communications module and to the mobile device, a signal representing a request to initiate a telephone call; and
receive, via the communications module and from the mobile device, a signal indicating initiation of the telephone call.

4. The self-service system of claim 3, wherein when sending, via the communication module and to the mobile device, the signal that includes the text-to-speech audio stream, the processor-executable instructions, when executed by the processor, further configure the processor to:
provide the text-to-speech audio stream to the mobile device via the telephone call.

5. The self-service system of claim 3, wherein the processor-executable instructions, when executed by the processor, further configure the processor to:
receive, via the communications module and from the mobile device, a signal indicating termination of the telephone call; and
terminate the trusted session between the self-service system and the mobile device.

6. The self-service system of claim 1, wherein the mobile device outputs the text-to-speech audio stream to a headset connected to the mobile device.

7. The self-service system of claim 1, wherein the text-to-speech audio stream includes a request for a user to submit an instruction via the mobile device.

8. The self-service system of claim 7, wherein the processor-executable instructions, when executed by the processor, further configure the processor to:
receive, via the communications module and from the mobile device, a signal that represents one or more input commands entered by the user via the mobile device;
determine one or more tasks to be performed based on the one or more input commands entered by the user; and
perform the one or more tasks.

9. The self-service system of claim 8, wherein the one or more input commands include pressing one or more buttons on a keypad associated with the mobile device.

10. The self-service system of claim 1, wherein the self-service system includes one of an automated teller machine (ATM), a gas station terminal or a self-checkout terminal.

11. The self-service system of claim 1, wherein when determining that the text-to-speech audio stream is to be sent to the mobile device, the processor-executable instructions, when executed by the processor, further configure the processor to, at least one of:
determine, based on account information stored in a database, that the text-to-speech audio stream is required;
receive an indication that the text-to-speech audio stream is required; or determine that an audio jack of the self-service system is in an unconnected state.

12. A computer-implemented method executed by a processor of a self-service system, the method comprising:
determining that a text-to-speech audio stream is to be sent to a mobile device;
initiating a trusted session between the self-service system and the mobile device;
engaging a text-to-speech module to convert text displayed on a display screen of the self-service system to the text-to-speech audio stream; and
sending, via a communications module and to the mobile device, a signal that includes the text-to-speech audio stream.

13. The computer-implemented method of claim 12, further comprising:
receiving an indication of an authentication token from one of the mobile device or an access card.

14. The computer-implemented method of claim 13, wherein initiating the trusted session between the self-service system and the mobile device comprises:
obtaining, from a database and based on the indication of the authentication token, a telephone number of the mobile device;
sending, via the communications module and to the mobile device, a signal representing a request to initiate a telephone call; and
receiving, via the communications module and from the mobile device, a signal indicating initiation of the telephone call.

15. The computer-implemented method of claim 14, wherein sending, via the communication module and to the mobile device, the signal that includes the text-to-speech audio stream comprises:
providing the text-to-speech audio stream to the mobile device via the telephone call.

16. The computer-implemented method of claim 12, wherein the mobile device outputs the text-to-speech audio stream to a headset connected to the mobile device.

17. The computer-implemented method of claim 12, wherein the text-to-speech audio stream includes a request for a user to submit an instruction via the mobile device.

18. The computer-implemented method of claim 17, further comprising:
receiving, via the communications module and from the mobile device, a signal that represents one or more input commands entered by the user via the mobile device;
determining one or more tasks to be performed based on the one or more input commands entered by the user; and
performing the one or more tasks.

19. The computer-implemented method of claim 12, wherein determining that the text-to-speech audio stream is to be sent to the mobile device further comprises:
determining, based on account information stored in a database, that the text-to-speech audio stream is required;
receiving an indication that the text-to-speech audio stream is required; or determining that an audio jack of the self-service system is in an unconnected state.

20. A non-transitory computer readable storage medium comprising computer-executable instructions which, when executed, configure a processor of a self-service system to:
determine that a text-to-speech audio stream is to be sent to a mobile device;
initiate a trusted session between the self-service system and the mobile device;
engage a text-to-speech module to convert text displayed on a display screen of the self-service system to the text-to-speech audio stream; and
send, via a communications module and to the mobile device, a signal that includes the text-to-speech audio stream.
